(19) United States
(12) Patent Application Publication
(10) Pub. No.: US 2021/0324816 A1
(43) Pub. Date: Oct. 21, 2021

(54) UNIQUE BLOCK RIB GEOMETRY FOR REDUCING LINER DISTORTION

(71) Applicant: Cummins Inc., Columbus, IN (US)

(72) Inventors: Xiling Zhou, Hubei Province (CN); Vijaysai Karuppiah Kumareshan, Columbus, IN (US); John Jerl Purcell, III, Louisa, VA (US); Mathew A. Clark, Darlington (GB)

(21) Appl. No.: 17/351,438

(22) Filed: Jun. 18, 2021

Related U.S. Application Data
(63) Continuation of application No. PCT/US2019/066271, filed on Dec. 13, 2019.
(60) Provisional application No. 62/781,943, filed on Dec. 19, 2018.

(51) Int. Cl. F02F 7/00; F02F 1/00

(52) U.S. Cl. CPC F02F 7/0065; F02F 1/004

(57) ABSTRACT

An engine block includes one or more cylinder bores wherein each cylinder bore is surrounded by a cylinder bore wall. The cylinder bore wall includes a liner stop mechanism to locate a liner in the cylinder bore. The cylinder bore includes a mid-portion that spans between an upper end and a lower end, wherein the liner stop mechanism can be located near the upper end, near the lower end, or the mid-portion. The engine block has an outer cylinder block wall that is exterior to the cylinder bore wall. The outer cylinder block wall includes a first rib positioned above the liner stop mechanism and a second rib positioned below the liner stop mechanism relative to a cylindrical axis of the cylinder bore. The first and second ribs straddle the liner stop mechanism to reduce rotation and buckling of the liner during operation of the engine.

### CROSS-REFERENCE TO RELATED APPLICATION

The present application is a continuation of International Patent App. No. PCT/US2019/66271 filed on Dec. 13, 2019, which claims the benefit of the filing date of U.S. Provisional Application No. 62/781,943 filed on Dec. 19, 2018, each of which is incorporated herein by reference.

### TECHNICAL FIELD

The present application relates generally to cylinder block walls for an internal combustion engine, and more particularly to a feature on the cylinder block walls partially surrounding a cylinder liner.

### BACKGROUND

Internal combustion engines include one or more cylinders wherein each cylinder includes a piston in the cylinder bore. During the combustion cycle, the piston moves in an upstroke direction and a downstroke direction relative to the cylinder bore. Cylinder walls of the cylinder bore can become very worn or damaged from use. If the engine is not equipped with replaceable sleeves, there is a limit to how far the cylinder walls can be bored or worn before the block must be sleeved or replaced.

Cylinder wall thickness is important to efficient thermal conductivity in the engine. When choosing sleeves, engines have specifications to how thick the cylinder walls should be to prevent overworking the coolant system. Each engine's needs are different, dependent on designed work load duty cycle and energy produced.

A cylinder liner is a cylindrical part to be fitted into an engine block to form a cylinder. The cylinder liner, serving as the inner wall of a cylinder, forms a sliding surface for the piston rings while retaining the lubricant within. The cylinder liner receives combustion heat through the piston and piston rings and transmits the heat to the coolant. The cylinder liner prevents the compressed gas and combustion gas from escaping outside. The cylinder liner should be designed such that it is hard to transform by high pressure and high temperature in the cylinder bore.

During operation of the piston in the combustion cycle, a liner seat of the cylinder liner can rotate which can cause the liner to buckle under load in the direction of the liner axis. Moreover, the liner can buckle due to loads from cylinder pressure or thermal expansion. If the liner is installed using press-fit or transitional fit techniques which can close under thermal or pressure related expansion, then the liner may rotate about the cylinder axis or expand which decreases the durability of the liner.

Therefore, further contributions in this area of technology are needed to improve the durability of the cylinder block walls of the engine. Therefore, there remains a significant need for the apparatuses, methods and systems disclosed herein.

### SUMMARY

One embodiment is a unique system, method, and apparatus that includes an engine block for an internal combustion engine. The engine block includes one or more cylinder bores wherein each cylinder bore is surrounded by a cylinder bore wall. The cylinder bore wall includes a liner stop mechanism configured to locate a liner in the cylinder bore. The cylinder bore includes a mid-portion that spans between an upper end and a lower end, wherein the liner stop mechanism can be located near the upper end, near the lower end, or in the mid-portion of the cylinder bore. The engine block has an outer cylinder block wall that is exterior to the cylinder bore wall. The outer cylinder block wall includes a first rib positioned above the liner stop mechanism and a second rib positioned below the liner stop mechanism relative to a cylindrical axis of the cylinder bore. The first and second ribs straddle the liner stop mechanism and reduce rotation of the liner seat hence reducing the propensity of the liner to buckle under load in the direction of the cylindrical axis of the cylinder bore, or due to loads from cylinder pressure or thermal expansion. The first and second ribs also act to reduce rotation or expansion of the liner wall where the liner is in contact with the engine block due to press-fit, or transitional fits which tend to close under thermal or pressure related expansion. The reduction or suppression of the liner by the first and second ribs improves the piston ring conformability wherein ring conformability is a function of the distortion of the cylinder bore and piston ring's ability to bend to these distortions. The reduction or suppression of the liner by the first and second ribs also improves the oil consumption of the engine.

This summary is provided to introduce a selection of concepts that are further described below in the illustrative embodiments. This summary is not intended to identify key or essential features of the claimed subject matter, nor is it intended to be used as an aid in limiting the scope of the claimed subject matter. Further embodiments, forms, objects, features, advantages, aspects, and benefits shall become apparent from the following description and drawings.

### BRIEF DESCRIPTION OF THE DRAWINGS

The concepts described herein are illustrative by way of example and not by way of limitation in the accompanying figures. For simplicity and clarity of illustration, elements illustrated in the figures are not necessarily drawn to scale. Where considered appropriate, references labels have been repeated among the figures to indicate corresponding or analogous elements.

FIG. 1 is a perspective view of an engine assembly of the present disclosure.

FIG. 2 is a cross-sectional view of the engine assembly of FIG. 1 of the present disclosure.

FIG. 3 is a right side view of the engine assembly of FIG. 1 of the present disclosure.

FIG. 4 is a left side view of the engine assembly of FIG. 1 of the present disclosure.

### DETAILED DESCRIPTION OF ILLUSTRATIVE EMBODIMENTS

For the purposes of promoting an understanding of the principles of the invention, reference will now be made to the embodiments illustrated in the drawings and specific language will be used to describe the same. It will nevertheless be understood that no limitation of the scope of the invention is thereby intended, any alterations and further modifications in the illustrated embodiments, and any further applications of the principles of the invention as illustrated therein as would normally occur to one skilled in the art to which the invention relates are contemplated herein.

A cylinder liner is a cylindrical part to be fitted into an engine block to form a cylinder. The cylinder liner, serving as the inner wall of a cylinder, forms a sliding surface for the piston rings while retaining the lubricant within. Some important functions of cylinder liners include an excellent sliding surface as well as high anti-galling properties, less wear on the cylinder liner itself, less wear on the partner piston ring, and less consumption of lubricant.

A cylinder liner or sleeve is installed by boring the cylinder to a size that is larger than normal inserted with an interference fit. Alternatively, the liners can be pressed into place, or they can be held in by a shrink fit. Cylinder wall thickness is important to efficient thermal conductivity in an internal combustion engine. When choosing sleeves, engines have specifications to how thick the cylinder walls should be to prevent overworking the coolant system. Each engine's needs are different, dependent on designed work load duty cycle and energy produced.

The cylinder liner receives combustion heat through the piston and piston rings and transmits the heat to the coolant. The cylinder liner prevents the compressed gas and combustion gas from escaping outside.

There are three types of liners such as the engine will have a bore in the base block or cylinder material, a dry liner which is a liner assembled into base block or cylinder without direct contact between coolant and liner, or wet liner which is a liner assembled into base block or cylinder with direct contact between coolant and liner.

Moreover, there are three liner types including top, mid and bottom stop. Generally, the cylinder head sealing surface is called the top end of the engine. The top-stop liner concept includes a flange on the top of the liner with which it is located into the cylinder block. The mid-stop has a similar flange at or near the middle of the liner, and the bottom stop has its locating flange near the lower end of the liner. In any of the top, mid, and bottom stop liner configurations, the cylinder bore of the engine block includes a liner stop mechanism that is configured to receive the liner.

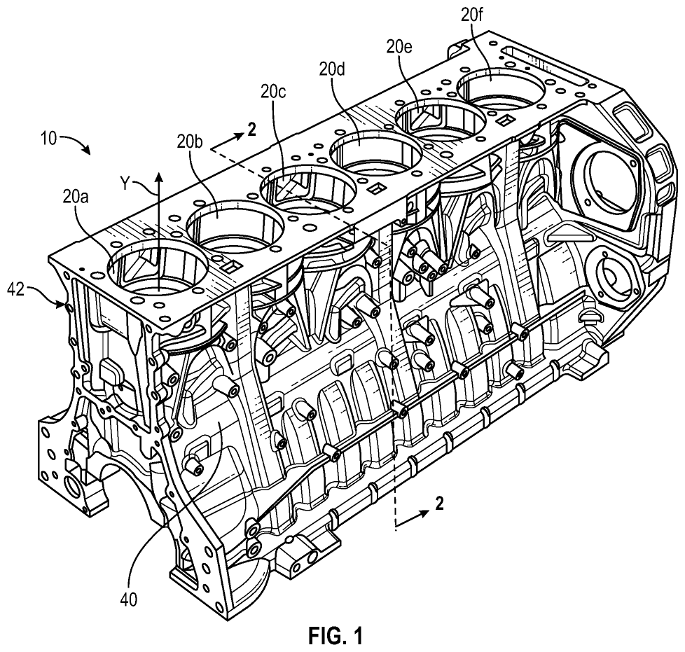

Turning now to the present application with reference to FIG. 1, an engine block 10 for an internal combustion engine (not illustrated). The engine is an internal combustion engine of any type, and can include a stoichiometric engine, a gasoline engine, alcohol engine (e.g. ethanol or methanol), or a natural gas engine. In the illustrated embodiment, the engine block 10 includes and at least partially defines six cylinder bores 20a, 20b, 20c, 20d, 20e, and 20f, in an in-line arrangement. However, the number of cylinders may be any number, and the arrangement of cylinders may be any arrangement, and is not limited to the number and arrangement shown in FIG. 1.

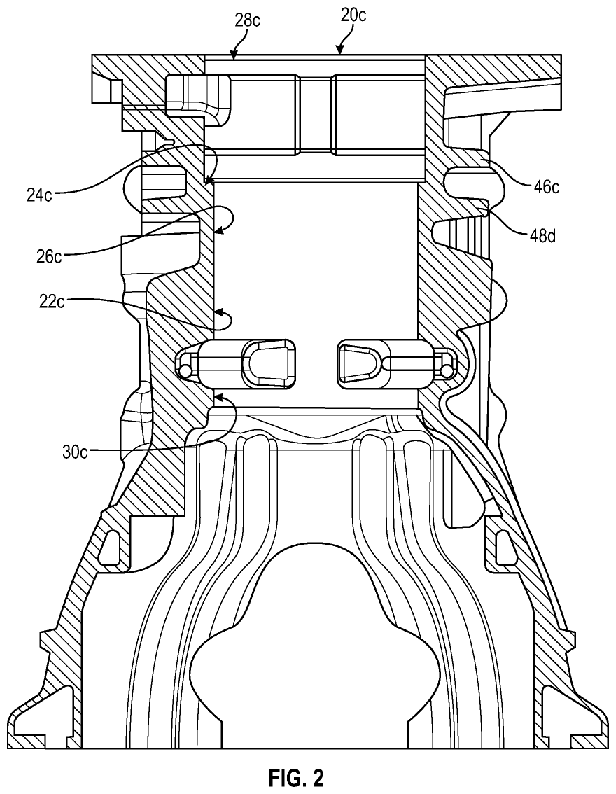

Each of the cylinder bores 20a-20f is surrounded by a cylinder bore wall 22a-22f, respectively. Each of the cylinder bore walls 22a-22f includes a liner stop mechanism 24a-24f configured to locate a liner or sleeve (not illustrated) in the cylinder bores 20a-20f. The liner stop mechanism 24a-24f in the illustrated embodiment is a lip, ledge, flange, rim, projecting edge, ridge or other configuration in the cylinder bore wall 22a-22f. In other embodiments, the liner stop mechanism 24a-24f can be configured differently to engage and retain the liner in the cylinder bores 20a-20f. The cylinder bore wall 22a-22f includes a mid-portion 26a-26f that spans between an upper end 28a-28f and a lower end 30a-30f. A cylindrical axis Y spans between the upper and lower ends 28a-28f and 30a-30f. In the illustrated embodiment in FIG. 2, the liner stop mechanism 24c is located in the mid-portion 26c of the cylinder bore wall 22c. In other embodiments, the liner stop mechanism 24a-24f is located at or near either the upper end 28a-28f or the lower end 30a-30f of the cylinder bore wall 22a-22f.

Each of the cylinder bores 20a-20f is configured to receive a cylinder liner (not illustrated) to define a combustion chamber. A piston (not shown) may be slidably disposed within each of the liners in the cylinder bores 20a-20f to reciprocate between a top-dead-center position and a bottom-dead-center position, and a cylinder head (not shown) may be associated with each of the cylinder bores 20a-20f. Each of the cylinder bores 20a-20f, its respective piston, and the cylinder head form a combustion chamber. In the illustrated embodiment, engine block 10 includes six such combustion chambers. However, it is contemplated that engine block 10 may include a greater or lesser number of cylinders and combustion chambers and that the cylinders and combustion chambers may be disposed in an “in-line” configuration, a “V” configuration, or in any other suitable configuration.

Cylinder liners may be inserted into cylinder bores 20a-20f under a variety of conditions. One such condition is a press fit, also known as an interference fit or friction fit, for example, creates an axial hold where adjoining parts share the same space by creating a slight elastic deformation and a compression force between the adjoining parts. Compression from the press fit increases the friction between the adjoining parts to a point where independent movement of the adjoining parts is not possible under normal operating conditions. Press fits between the cylinder liner and engine block 10 may be created using physical presses, principles of thermal expansion or other suitable method.

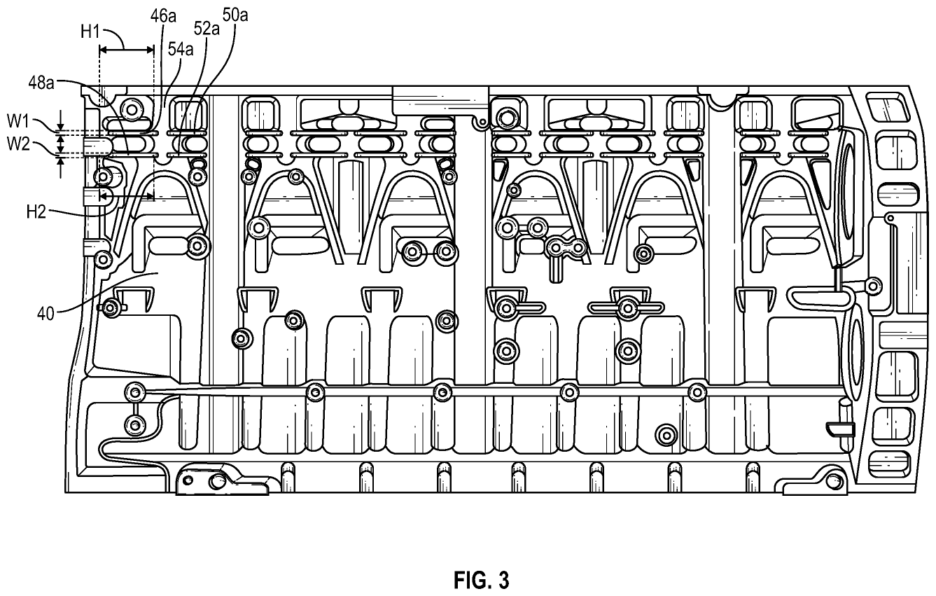

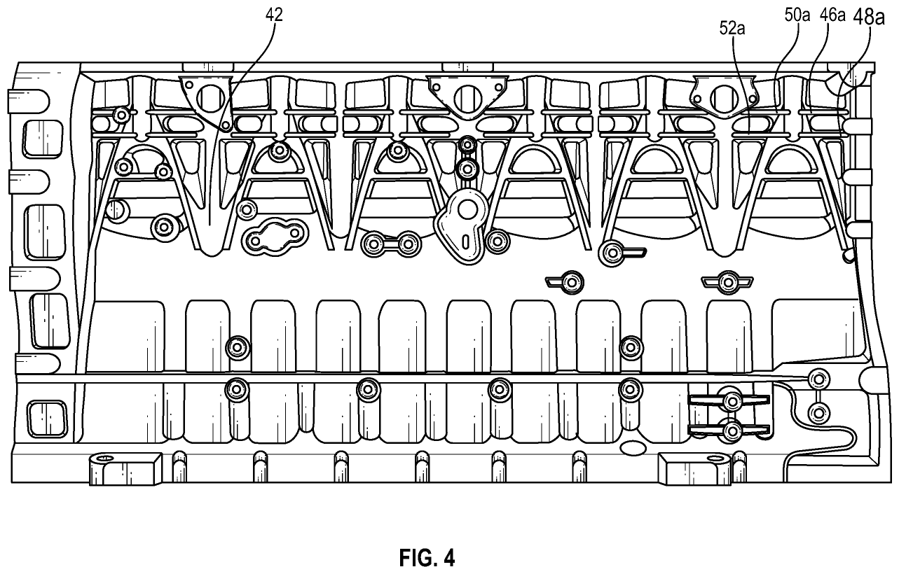

As illustrated in FIGS. 3 and 4, the engine block 10 includes a first outer cylinder block wall 40 opposite a second outer cylinder block wall 42 with the cylinders bores 20a-20f between the first and second outer cylindrical block walls 40 and 42. Each of the first and second outer cylinder block walls 40 and 42 surround at least a portion of the cylinder bore walls 22a-22f. The first outer cylinder block wall 40 includes a first rib 46a positioned above the liner stop mechanism 24a and a second rib 48a positioned below the liner stop mechanism 24a relative to the cylindrical axis Y of the cylinder bore 20a. In the illustrated embodiment, the first outer cylinder block wall 40 also includes a third rib 50a positioned above the liner stop mechanism 24 and a fourth rib 52a positioned below the liner stop mechanism 24a relative to the cylindrical axis Y of the cylinder bore 20a. A head boss 54a is positioned between the first and third ribs 46a and 50a and the second and fourth ribs 48a and 52a.

In other forms, the first and third ribs 46a and 50a may be one monolithic rib without the presence of the head boss 54a. Similarly, the second and fourth ribs 48a and 52a may be one monolithic rib without the presence of the head boss 54a. As such, the first and third ribs 46a and 50a form a single rib that is located above the liner stop mechanism 24a. Similarly, the second and fourth ribs 48a and 52a form a single rib that is located below the liner stop mechanism 24a. In yet other forms, the first and third ribs 46a and 50a may be a single rib and the second and fourth ribs 48a and 52a may be separate ribs, or vice versa. The second outer cylinder block wall 42 also includes similar first and second ribs as described with respect to the first outer cylinder block wall 40 therefore for the sake of brevity these will not be described again.

The first outer cylindrical block wall 40 includes additional first and second ribs similar to first and second ribs 46a and 48a for each of the remaining cylinder bores 20b-20f. The first outer cylindrical block wall 40 includes additional third and fourth ribs similar to third and fourth ribs 50a and 52a for each of the remaining cylinder bores 20b-20f. The additional first, second, third and fourth ribs will not be described for the sake of brevity.

The first, second, third, and fourth ribs 46a, 48a, 50a, and 52a generally follow the circumference of cylinder bore 20a or the liner that would be installed therein. The first rib 46a is placed above the liner stop mechanism 24a and the second rib 48a is positioned below the liner stop mechanism 24a, with a space there between in the direction of the cylindrical axis Y. The first and second ribs 46a and 48a act to reduce rotation of a liner seat of a liner installed in the cylinder bore 20a and reduce the propensity of the liner to buckle under loads in the direction of a liner axis, or due to loads from cylinder pressure or thermal expansion. The first and second ribs 46a and 48a also act to reduce rotation or expansion of a liner wall of the liner, where the liner is in contact with the engine block 10 due to press-fit, or transitional fits which typically close under thermal or pressure related expansion.

In one form, the first rib 46a and the third rib 50a are positioned closer to the liner stop mechanism 24a than the second rib 48a and the fourth rib 52a as measured relative to the cylindrical axis Y. In another form, the second rib 48a and fourth rib 52a are positioned closer to the liner stop mechanism 24a than the first rib 46a and the third rib 50a as measured relative to the cylindrical axis Y. In yet another embodiment, the first, second, third, and fourth ribs 46a, 48a, 50a, and 52a are positioned equidistant from the liner stop mechanism 24a as measured relative to the cylindrical axis Y.

The first rib 46a has a first width W1 and the second rib 48a has a second width W2 wherein the first rib 46a and the second rib 48a extend in a direction of the cylindrical axis Y of the cylinder bore 20a. In one form, the first width W1 and the second width W2 are the same, in other forms they are different. The first rib 46a has a first height H1 and the second rib 48a has a second height H2 such that the first and the second ribs 46a and 48a extend in a direction perpendicular to the cylindrical axis Y of the cylinder bore 20a. The third rib 50a is similar to the first rib 46a, and the fourth rib 52a is similar to the second rib 48a.

The unique configuration of the first, second, third, and fourth ribs 46a, 48a, 50a, and 52a of the first outer cylinder block wall 40 and the corresponding ribs on the second outer cylinder block wall 42 that surround or partially surround the wet cylinder liner in the cylinder bore 20a beneficially reduce deformation or distortion of the wet cylinder liner under installation and operating conditions. The first, second, third, and fourth ribs 46a, 48a, 50a, and 52a of the first outer cylinder block wall 40 and the corresponding ribs on the second outer cylinder block wall 42 also reduce engine oil consumption and can apply on top, mid or bottom stop liner configurations. Moreover the first, second, third, and fourth ribs 46a, 48a, 50a, and 52a do not add too much weight or cost to manufacture. The first, second, third, and fourth ribs 46a, 48a, 50a, and 52a are also easy to manufacture for gray iron block casting.

As is evident from the figures and text presented above, a variety of aspects of the present disclosure are contemplated.

Various aspects of the present application are contemplated. According to one aspect, an apparatus comprising an engine block for an internal combustion engine, the engine block having a cylinder bore surrounded by a cylinder bore wall, the cylinder bore wall including a liner stop mechanism configured to locate a liner in the cylinder bore, the engine block having an outer cylinder block wall that surrounds at least a portion of the cylinder bore wall, the outer cylinder block wall including a first rib positioned above the liner stop mechanism and a second rib positioned below the liner stop mechanism relative to a cylindrical axis of the cylinder bore.

In one embodiment, the first rib is positioned closer to the liner stop mechanism than the second rib.

In one embodiment, the second rib is positioned closer to the liner stop mechanism than the first rib.

In one embodiment, the first rib and the second rib are positioned equidistant from the liner stop mechanism.

In one embodiment, the first rib has a first width and the second rib has a second width, the first and the second ribs extend in a direction of the cylindrical axis of the cylinder bore. In a refinement of this embodiment, the first width and the second width are the same.

In one embodiment, the first rib has a first height and the second rib has a second height, the first and the second ribs extend in a direction perpendicular to the cylindrical axis of the cylinder bore.

In one embodiment, the outer cylinder block wall includes a first outer cylinder block wall and a second outer cylinder block wall, and each of the first and the second outer cylinder block walls includes the first and second ribs.

In one embodiment, the cylinder bore includes a mid-portion that spans between an upper end and a lower end, the liner stop mechanism being located near the upper end of the cylinder bore.

In one embodiment, the cylinder bore includes a mid-portion that spans between an upper end and a lower end, the liner stop mechanism being located in the mid-portion of the cylinder bore.

In one embodiment, the cylinder bore includes a mid-portion that spans between an upper end and a lower end, the liner stop mechanism being located near the lower end of the cylinder bore.

In one embodiment, further comprises a liner assembled in the cylinder bore.

According to another aspect, an apparatus comprising an engine block for an internal combustion engine, the engine block having at least one cylinder bore surrounded by a cylinder bore wall, the cylinder bore wall including a liner stop mechanism configured to locate a liner in the cylinder bore, the engine block having an outer cylinder block wall with a first rib and a second rib arranged to straddle the liner stop mechanism exteriorly of the cylinder bore wall.

In one embodiment, the first rib is positioned closer to the liner stop mechanism than the second rib.

In one embodiment, the second rib is positioned closer to the liner stop mechanism than the first rib.

In one embodiment, the first rib and the second rib are positioned equidistant from the liner stop mechanism.

In one embodiment, the first rib has a first width and the second rib has a second width, the first and the second ribs extend in a direction of the cylindrical axis of the cylinder bore.

In one embodiment, the first rib has a first height and the second rib has a second height, the first and the second ribs extend in a direction perpendicular to the cylindrical axis of the cylinder bore.

In one embodiment, the at least one cylinder bore includes a plurality of cylinder bores arranged in line, each of the cylinder bores having a set of the first and second ribs wherein a first set of the first and second ribs extend towards an adjacent set of the first and second ribs.

In one embodiment, the outer cylinder block wall includes a first outer cylinder block wall and a second outer cylinder block wall, and each of the first and the second outer cylinder block walls includes the first and second ribs.

In one embodiment, the cylinder bore includes a mid-portion that spans between an upper end and a lower end, the liner stop mechanism being located near the upper end of the cylinder bore.

In one embodiment, the cylinder bore includes a mid-portion that spans between an upper end and a lower end, the liner stop mechanism being located in the mid-portion of the cylinder bore.

In one embodiment, the cylinder bore includes a mid-portion that spans between an upper end and a lower end, the liner stop mechanism being located near the lower end of the cylinder bore.

In one embodiment, further comprises a liner assembled in the cylinder bore.

In one embodiment, the first rib includes two ribs and the second rib includes two ribs.

In the above description, certain relative terms may be used such as “up,” “down,” “upper,” “lower,” “horizontal,” “vertical,” “left,” “right,” “proximal,” “distal,” and the like. These terms are used, where applicable, to provide some clarity of description when dealing with relative relationships. But, these terms are not intended to imply absolute relationships, positions, and/or orientations. For example, with respect to an object, an “upper” surface can become a “lower” surface simply by turning the object over. Nevertheless, it is still the same object.

Reference throughout this specification to “one embodiment,” “an embodiment,” or similar language means that a particular feature, structure, or characteristic described in connection with the embodiment is included in at least one embodiment of the present disclosure. Appearances of the phrases “in one embodiment,” “in an embodiment,” and similar language throughout this specification may, but do not necessarily, all refer to the same embodiment. Similarly, the use of the term “implementation” means an implementation having a particular feature, structure, or characteristic described in connection with one or more embodiments of the present disclosure, however, absent an express correlation to indicate otherwise, an implementation may be associated with one or more embodiments.

The described features, structures, advantages, and/or characteristics of the subject matter of the present disclosure may be combined in any suitable manner in one or more embodiments and/or implementations. In the following description, numerous specific details are provided to impart a thorough understanding of embodiments of the subject matter of the present disclosure. One skilled in the relevant art will recognize that the subject matter of the present disclosure may be practiced without one or more of the specific features, details, components, materials, and/or methods of a particular embodiment or implementation. In some instances, the benefit of simplicity may provide operational and economic benefits and exclusion of certain elements described herein is contemplated as within the scope of the invention herein by the inventors to achieve such benefits. In other instances, additional features and advantages may be recognized in certain embodiments and/or implementations that may not be present in all embodiments or implementations. Further, in some instances, well-known structures, materials, or operations are not shown or described in detail to avoid obscuring aspects of the subject matter of the present disclosure. The features and advantages of the subject matter of the present disclosure will become more fully apparent from the following description and appended claims, or may be learned by the practice of the subject matter as set forth hereinafter.

The present subject matter may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. An apparatus comprising:
an engine block for an internal combustion engine, the engine block having a cylinder bore surrounded by a cylinder bore wall, the cylinder bore wall including a liner stop mechanism positioned a distance from an upper end of the cylinder bore wall, the liner stop mechanism locates a liner in the cylinder bore, the engine block having an outer cylinder block wall that surrounds at least a portion of the cylinder bore wall, the outer cylinder block wall including a first rib positioned above the liner stop mechanism and a second rib positioned below the liner stop mechanism relative to a cylindrical axis of the cylinder bore, wherein the first rib is located below the upper end of the cylinder bore wall and the second rib is located above a lower end of the cylinder bore wall.

2. The apparatus of claim 1, wherein the first rib is positioned closer to the liner stop mechanism than the second rib.

3. The apparatus of claim 1, wherein the second rib is positioned closer to the liner stop mechanism than the first rib.

4. The apparatus of claim 1, wherein the first rib and the second rib are positioned equidistant from the liner stop mechanism.

5. The apparatus of claim 1, wherein the first rib has a first width and the second rib has a second width, the widths of the first and the second ribs extend in a direction of the cylindrical axis of the cylinder bore, and the first width and the second width are the same.

6. (canceled)

7. The apparatus of claim 1, wherein the first rib has a first height and the second rib has a second height, the heights of the first and the second ribs extend in a direction perpendicular to the cylindrical axis of the cylinder bore.

8. The apparatus of claim 1, wherein the outer cylinder block wall includes a first outer cylinder block wall and a second outer cylinder block wall, and each of the first and the second outer cylinder block walls includes the first and second ribs.

9. The apparatus of claim 1, wherein the cylinder bore includes a mid-portion that spans between an upper end and a lower end, the liner stop mechanism being located near the upper end of the cylinder bore.

10. The apparatus of claim 1, wherein the cylinder bore includes a mid-portion that spans between an upper end and a lower end, the liner stop mechanism located in the mid-portion of the cylinder bore.

11. The apparatus of claim 1, wherein the cylinder bore includes a mid-portion that spans between an upper end and a lower end, the liner stop mechanism being located near the lower end of the cylinder bore.

12. The apparatus of claim 1, further comprising:
a liner assembled in the cylinder bore wherein a portion of the liner is supported on the liner stop mechanism.

13. An apparatus comprising:
an engine block for an internal combustion engine, the engine block having at least one cylinder bore surrounded by a cylinder bore wall, the cylinder bore wall including a liner stop mechanism positioned away from an upper end of the cylinder bore wall, the liner stop mechanism locates a liner in the cylinder bore, the engine block having an outer cylinder block wall with a first rib and a second rib arranged to straddle the liner stop mechanism exteriorly of the cylinder bore wall, wherein the first rib is located below the upper end of the cylinder bore wall and the second rib is located above a lower end of the cylinder bore wall.

14. The apparatus of claim 13, wherein the first rib is positioned closer to the liner stop mechanism than the second rib.

15. The apparatus of claim 13, wherein the second rib is positioned closer to the liner stop mechanism than the first rib.

16. The apparatus of claim 13, wherein the first rib and the second rib are positioned equidistant from the liner stop mechanism.

17. The apparatus of claim 13, wherein the first rib has a first width and the second rib has a second width, the widths of the first and the second ribs extend in a direction of the cylindrical axis of the cylinder bore, and the first width and the second width are the same.

18. (canceled)

19. The apparatus of claim 13, wherein the at least one cylinder bore includes a plurality of cylinder bores arranged in line, each of the cylinder bores having a set of the first and second ribs wherein a first set of the first and second ribs extend towards an adjacent set of the first and second ribs.

20. (canceled)

21. The apparatus of claim 13, wherein the cylinder bore includes a mid-portion that spans between an upper end and a lower end, the liner stop mechanism being located near the upper end of the cylinder bore.

24. The apparatus of claim 13, further comprising:
a liner assembled in the cylinder bore wherein the liner stop mechanism engages with the liner to retain the liner in the cylinder bore.

25. The apparatus of claim 13, wherein the first rib includes two ribs and the second rib includes two ribs.
